(19) United States
(12) Patent Application Publication
(10) Pub. No.: US 2024/0227593 A1
(43) Pub. Date: Jul. 11, 2024

(54) Floor-Mounted Charging Device For Wireless Charging Of Electric Vehicles

(71) Applicant: Siemens Aktiengesellschaft, München (DE)

(72) Inventors: Monika Poebl, München (DE); Michael Finkenzeller, Feldkirchen-Westerham (DE); Matthias de Vigneux, München (DE)

(73) Assignee: Siemens Aktiengesellschaft, München (DE)

(21) Appl. No.: 18/408,503

(22) Filed: Jan. 9, 2024

(30) Foreign Application Priority Data
Jan. 10, 2023 (EP) 23150920.9

(51) Int. Cl. B60L 53/302; B60L 53/12; H01F 27/28; H02G 3/03; H02G 3/36; H02J 50/00

(52) U.S. Cl. CPC B60L 53/302; B60L 53/12; H01F 27/2876; H02G 3/03; H02G 3/36; H02J 50/005; H02J 2310/48

(57) ABSTRACT

Various embodiments of the teachings herein include a floor-mounted charging device for wireless charging of an electric vehicle. An example device includes: an electric circuit board with capacitors; a cuboid cooling plate with cooling ribs formed therein; and a high-frequency connecting cable to create an electrical connection between the circuit board and a remote power electronics. A rectangular first region is cut out from the cooling ribs. The circuit board is arranged in thermal communication on the cooling plate in the first region. An annular second region is cut out from the cooling ribs around the first region. A surplus length of the connecting cable can be stored wound up in the second region if required.

### CROSS-REFERENCE TO RELATED APPLICATIONS

This application claims priority to EP Application No. 23150920.9 filed Jan. 10, 2023, the contents of which are hereby incorporated by reference in their entirety.

### TECHNICAL FIELD

The present disclosure relates to electric vehicles. Various embodiments of the teachings herein include methods and/or systems for floor-mounted charging device (charging pad with coil) for wireless charging of an electric vehicle.

### BACKGROUND

Irrespective of the grammatical gender of a specific term, persons with male, female or other gender identity are also included. In modern times, electrical mobility is playing an ever more important role. More and more people are opting for electric vehicles in order to travel in environmentally friendly fashion and reduce dependence on fossil fuels. One challenge in the use of electric vehicles however is the need to recharge them regularly. This is where the concept of wireless charging of electric vehicles comes in. By use of this concept, electric vehicle drivers can easily and conveniently charge their vehicle without the need to handle bulky cables.

For wireless charging of electric vehicles, substantially three components are required: a wall box, a charging pad, and a vehicle receiver. The wall box accommodates the necessary power electronics which convert the mains power supply into high-frequency energy which is output to the charging pad. The charging pad contains the primary coil with ferrites, screening and resonant adaptation network which converts the high-frequency energy from the wall box into a magnetic field, via which energy can be efficiently transferred to the vehicle receiver. The receiver in the vehicle receives the energy from the magnetic field generated by the charging pad and converts the energy into direct current in order to drive the electric vehicle and charge its battery.

International standard ISO/FDIS 19363 Annex B.2 describes the floor coil unit (charging pad, primary device) for wireless power transfer of less than 11 kW as the reference design. In addition, a resonance circuit with a coil and capacitor arrangement (tuning capacitors) is defined. The series-parallel circuit of the capacitors is created on a circuit board which, in order not to generate additional power losses, should be placed close to the ground coils. With such a design, a thermal connection to a housing is required.

The required power electronics for operating the ground coil unit are mounted in an additional housing, e.g. in the above-mentioned wall box. Since the electrical connection between the two units, wall box and ground coil unit, must conduct a high-frequency alternating current with low losses, a high-frequency braided cable with fine wires and insulated individual cores is required. The contacting of such a braided cable to e.g. a cable terminal which can be contacted at a screw contact can only be achieved with special connecting techniques which can only be performed by immovable machines.

Thus it is difficult to make up the required length of a connecting cable suitable for local conditions, such as would be necessary e.g. in a garage. Thus a possibility for stowing the surplus braided cable must be provided.

### SUMMARY

The teachings of the present disclosure include systems and/or methods for wireless charging of electric vehicles securing a surplus length of a connecting cable which connects a floor-mounted charging device with power electronics. For example, some embodiments include a floor-mounted charging device (1) for wireless charging of an electric vehicle, comprising: an electric circuit board (2) with capacitors, a cuboid cooling plate (3), wherein cooling ribs (3.1) are formed in the cooling plate, and a high-frequency connecting cable (4) which creates an electrical connection between the circuit board (2) and a remote power electronics (5), characterized in that a rectangular first region (B1) is cut out from cooling ribs (3.1), wherein the circuit board (2) is arranged thermally conductively on the cooling plate (3) in the first region, and an annular second region (B2) is cut out from cooling ribs around the first region, wherein a surplus length of the connecting cable (4) can be stored wound up in the second region if required.

In some embodiments, the second region (B2) is annular.

In some embodiments, there is at least one groove (3.2) in the cooling plate (3) in the second region (B2), wherein the groove is configured to at least partially accommodate the surplus length of the connecting cable (4).

In some embodiments, there are holding elements which are configured to releasably fix the surplus length of the connecting cable (4) in the second region (B2).

In some embodiments, the holding element is a clamp, a cable tie or a cable clip.

In some embodiments, the connecting cable (4) is a braided cable.

In some embodiments, a rectilinear third region (B3) connecting the first region (B1) to the edge of the cooling plate (3) is cut out from cooling ribs (3.1), wherein a part of the connecting cable (4) from the power electronics (5) to the circuit board (2) can be guided in the third region.

In some embodiments, there is a housing (1.1) which is configured to accommodate the cooling plate (3), the circuit board (2) and further components.

As another example, some embodiments include a charging arrangement for wireless charging of an electric vehicle, characterized by a floor-mounted charging device (1) as described herein, and a wall box (6) in which the power electronics (5) are arranged.

### BRIEF DESCRIPTION OF THE DRAWINGS

Further features and advantages of the teachings herein are clear from the following explanations of an exemplary embodiment on the basis of schematic drawings. In the figures:

FIG. 1 shows an isometric view of a floor-mounted coil unit with a braided cable storage unit incorporating teachings of the present disclosure;

FIGS. 2-4 show a top view of a cuboid cooling body with cooling ribs and a braided cable storage unit incorporating teachings of the present disclosure; and

FIG. 5 shows a diagram of an arrangement for charging an electric vehicle incorporating teachings of the present disclosure.

### DETAILED DESCRIPTION

From in-house thermal studies and simulations, it was found that a cut-out for the braided cable in the middle of a floor-mounted charging device is a particularly suitable location for mounting a capacitor circuit board. The requirements of proximity to the transmission coil, and also the necessary heat dissipation of the circuit board, are fulfilled. Since the strands of the connecting cable must be connected to the capacitor circuit board, in a further aspect, this region is particularly suitable for stowing the surplus braid (e.g. cable store). For this, a suitable space must be created in this region. This is designed such that different lengths are available for braided cable storage. This may be provided by corresponding cut-outs in the base plate of the cooling body.

Some embodiments of the teachings herein include a floor-mounted charging device for wireless charging of electric vehicle, comprising: an electric circuit board with capacitors, a cuboid cooling plate, wherein cooling ribs are formed in the cooling plate, and a high-frequency connecting cable which creates an electrical connection between the circuit board and a remote power electronics, wherein a rectangular first region is cut out from cooling ribs (the cooling ribs are absent there), wherein the circuit board is arranged thermally conductively on the cooling plate in the first region, and wherein an annular second region is cut out from cooling ribs around the first region (i.e. surrounding the first region), wherein a surplus length of the connecting cable can be stored wound up in the second region if required. Thus a cable store for surplus cable lengths of the connecting cable is formed.

In some embodiments, the second region may be annular.

In some embodiments, the floor-mounted charging device comprises at least one groove in the cooling plate in the second region, wherein the groove is configured to at least partially accommodate the surplus length of the connecting cable.

In some embodiments, the floor-mounted charging device comprises holding elements which are configured to releasably fix the surplus length of the connecting cable in the second region.

In some embodiments, the holding element may be a clamp, a cable tie or a cable clip.

In some embodiments, the connecting cable may be a braided cable.

In some embodiments, a rectilinear third region connecting the first region to the edge of the cooling plate may be cut out from cooling ribs, in which region a part of the connecting cable from the power electronics to the circuit board can be guided.

In some embodiments, the floor-mounted charging device comprises a housing which is configured to accommodate the cooling plate, the circuit board and further components.

Some embodiments include a charging arrangement for wireless charging of an electric vehicle, comprising: a floor-mounted charging device described herein, and a wall box in which the power electronics are arranged.

Because the circuit board (containing capacitors) is accommodated directly below the coil for energy transmission, the geometric dimensions of the floor-mounted charging device are smaller and it is lighter than if it were arranged on an aluminum plate next to said coil. Because of the cut-out for storing the connecting cable on the underside of the cooling plate, an additional mechanical protection of the connecting cable can be achieved in the region of the cable inlet. The stowing of the surplus length inside the housing allows factory make-up of the connecting cable. Thus a sophisticated quality control can be carried out by the manufacturer and need not be performed on-site by specialist personnel or machines.

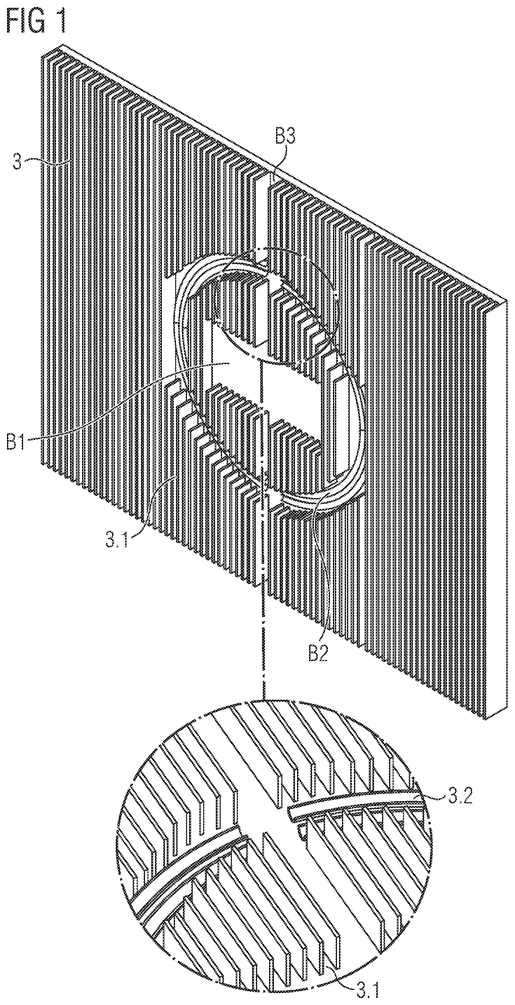

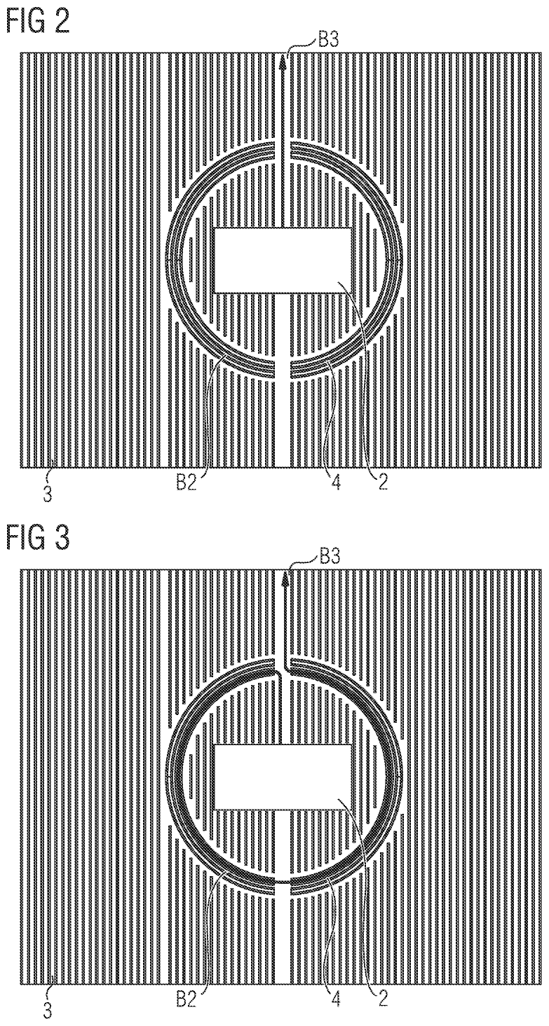

A concrete example of the teachings herein is shown in the drawings in FIGS. 1 to 4, wherein the floor-mounted charging device 1 comprises a cooling plate 3. The drawings in FIGS. 2 to 4 show different surplus cable lengths of a connecting cable 4.

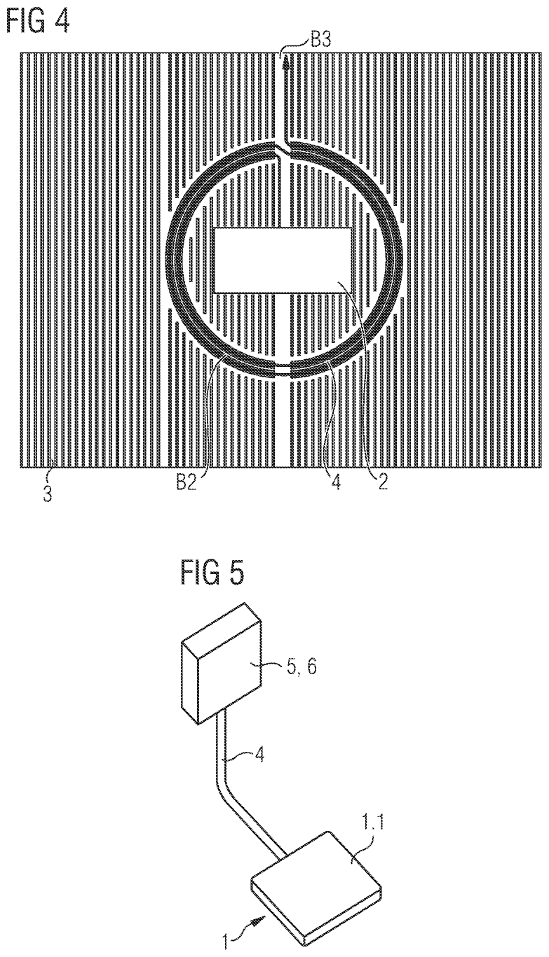

FIG. 1 shows an isometric view of the cooling plate 3 of a floor-mounted charging device 1 incorporating teachings of the present disclosure (see FIG. 5). The cooling plate 3 has cooling ribs 3.1 which are absent in some regions, for example cut away, such as in a first region B1 which is formed rectangular for accommodating the electric circuit board 2 (see FIGS. 2 to 4). A rectilinear third region B3 runs from the first region B1 to the edge of the cooling plate 3. In this third region B3, the connecting cable 4 (see FIGS. 2 to 4) can be guided away from the circuit board 2 to the edge of the cooling plate 3.

A second, possibly annular region B2 is formed around the first region B1 and serves to receive or store a surplus cable length of the connecting cable 4. In some embodiments, grooves 3.2, in which the connecting cable 4 can be at least partly arranged, are made in the cooling plate 3 in the second region B2.

The top views in FIGS. 2 to 4 show different cable lengths of the connecting cable 4 which is arranged in the cut-outs of the second and third regions B2 and B3. Thus a robust and safe store for surplus lengths of the connecting cable 4 is formed. The circuit board 2 is arranged in the middle of the cooling plate 3. The connecting cable 4 can be fixed in position with holding elements (not shown). For this, for example, cable ties, cable clips or clamps are suitable.

FIG. 5 shows a view of a charging arrangement for wireless charging of an electric vehicle with a charging device 1 according to FIGS. 1 to 4. The connecting cable 4 connects the wall box 6 containing the power electronics 5 to the floor-mounted charging device 1 which has a housing 1.1 for accommodating the components.

Although the teachings herein have been illustrated and described more specifically in detail by means of the exemplary embodiments, the scope of the disclosure is not restricted by the described examples and other variations may be derived therefrom by a person skilled in the art without departing from the scope of protection thereof.

### LIST OF REFERENCE SIGNS

1 Floor-mounted charging device
1.1 Housing
2 Circuit board
3 Cooling plate
3.1 Cooling ribs
3.2 Groove
4 Connecting cable
5 Power electronics
6 Wall box
B1 First region
B2 Second region
B3 Third region

1. A floor-mounted charging device for wireless charging of an electric vehicle, the device comprising:
an electric circuit board with capacitors;
a cuboid cooling plate with cooling ribs formed therein; and
a high-frequency connecting cable to create an electrical connection between the circuit board and a remote power electronics;
wherein a rectangular first region is cut out from the cooling ribs;
the circuit board is arranged in thermal communication on the cooling plate in the first region;
a second region is cut out from the cooling ribs around the first region;
a surplus length of the connecting cable can be stored wound up in the second region if required.

2. The floor-mounted charging device as claimed in claim 1, wherein the second region is annular.

3. The floor-mounted charging device as claimed in claim 1, further comprising a groove in the cooling plate in the second region;
wherein the groove at least partially accommodates the surplus length of the connecting cable.

4. The floor-mounted charging device as claimed in claim 1, further comprising holding elements to releasably fix the surplus length of the connecting cable in the second region.

5. The floor-mounted charging device as claimed in claim 4, wherein the holding elements comprise clamps, cable ties, and/or cable clips.

6. The floor-mounted charging device as claimed in claim 1, wherein the connecting cable comprises a braided cable.

7. The floor-mounted charging device as claimed in claim 1, further comprising a rectilinear third region connecting the first region to an edge of the cooling plate and cut out from cooling ribs;
wherein a part of the connecting cable from the power electronics to the circuit board can be guided in the third region.

8. The floor-mounted charging device as claimed in claim 1, further comprising a housing to accommodate the cooling plate and the circuit board.

9. A charging arrangement for wireless charging of an electric vehicle, the arrangement comprising:
an electric circuit board with capacitors;
a cuboid cooling plate with cooling ribs formed therein; and
a high-frequency connecting cable to create an electrical connection between the circuit board and a remote power electronics;
wherein a rectangular first region is cut out from the cooling ribs;
the circuit board is arranged in thermal communication on the cooling plate in the first region;
a second region is cut out from the cooling ribs around the first region;
a surplus length of the connecting cable can be stored wound up in the second region if required; and
a wall box housing the power electronics.
